(19) United States
(12) Patent Application Publication
(10) Pub. No.: US 2024/0207922 A1
(43) Pub. Date: Jun. 27, 2024

(54) HOT FORMING A CAST FORGING INGOT

(71) Applicant: GFM GmbH, Steyr (AT)

(72) Inventors: Gottfried Blaimschein, Steyr (AT); Robert Koppensteiner, Steyr (AT)

(73) Assignee: GFM GmbH, Steyr (AT)

(21) Appl. No.: 18/558,199

(22) PCT Filed: Mar. 23, 2022
(86) PCT No.: PCT/AT2022/060087

§ 371 Date: Oct. 31, 2023

(30) Foreign Application Priority Data
May 12, 2021 (AT) A50368/2021

(51) Int. Cl. B21J 7/14; B21J 1/04; B21J 7/28; B21J 9/12; B21J 9/18

(52) U.S. Cl. CPC B21J 7/14; B21J 1/04; B21J 7/28; B21J 9/12; B21J 9/18

(57) ABSTRACT

A method for hot forming of a cast forging ingot uses a forging device with radially guided forging dies of which each have two die parts, which can be radially moved relative to each other and of which the inner die part bearing a forging tool is drive-connected, using a hydraulic cylinder, to the other, outer die part, which can be driven using an eccentric drive. In order to provide advantageous forging conditions, the forging ingot is formed under heat, first using the forging dies driven by the eccentric drive, in near-surface forge processing with a degree of deformation which is above the critical degree of deformation and which excludes the formation of cracks, and then, with the outer die parts stopped, with the aid of the inner die parts driven by the hydraulic cylinders, in forge pressing with a bite ratio of >0.5.

TECHNICAL FIELD

This application relates to hot forming a cast forging ingot with the aid of a forging device.

### BACKGROUND

In order to convert the cast structure of a cast forging ingot into a largely pore-free, recrystallized structure, the forging ingot is subjected to hot forming by a press forging operation. A large bite ratio, i.e. the ratio of the pressed length of the forging saddle to the diameter of the forging ingot before the press stroke, is intended to achieve sufficient core forming for pore reduction despite a small reduction. However, due to the large bite ratio, there are considerable differences in the degree of deformation caused by the press stroke of the forging die over the pressed length of the forging saddle, which leads to cracking in the surface region.

In order to be able to hot-form workpieces with a forging device either by a forging press with slow forming speed and high forces at a high bite ratio or by a radial forging with higher forming speeds and small bite ratios, it is known (WO 2015/118502 A1, EP 1 093 871 A2) to assemble the forging die, which receives a forging tool and is guided radially to the forging axis, from two die parts between which a hydraulic cylinder is provided. The outer of the two die parts is driven by an eccentric drive which, when the hydraulic cylinder between the two die parts is locked, drives the inner die part receiving a forging tool in the sense of radial forging with a comparatively high number of blows. However, if the outer die part is uncoupled from an eccentric drive of the outer die part and held fixed against displacement, the inner die part can be driven in the sense of a press forging when the hydraulic cylinder between the two die parts is pressurized and the outer die part is held in place. The upper die part can be uncoupled from the eccentric drive using a clamping wedge that can be displaced in a clamping gap between the die guide and the outer die part (WO 2015/118502 A1), which supports the outer die part against a forging stroke. However, it is also possible (EP 1 093 871 A2) to provide a shift coupling in the drive train between the eccentric drive and the electric motor provided for the eccentric drive so that, when decoupled, forces can be transferred from the outer die part via the eccentric drive to the eccentric shaft bearing without torque loading of the eccentric drive when the eccentric drive is preferably in the outer dead center position.

Regardless of the method of decoupling the outer die part from the eccentric drive, the difficulty in forge pressing remains that with a bite ratio >0.5, as is required to influence the microstructure in the core area of the forging ingot (EP 1 747 076 B1), uneven loading of surface regions over the pressed length of the forging saddle is unavoidable, which entails the risk of cracking in the surface region.

To avoid cracking despite good forging of the core area of a forging ingot, a forging method has been proposed (EP 0 255 635 A2) in which the workpiece is offset or displaced in the direction of workpiece extension between an upper and a lower saddle of the forging press before the respective forging stroke only to such an extent that the bite edge of the respective preceding bite on the workpiece comes to lie within the saddle edges. This means that the pressed saddle length and thus also the bite ratio decreases with each forging pass made under a bite offset, so that there is a forging method starting from a maximum bite ratio with gradually decreasing bite ratios, which leads in particular in the area of the maximum bite ratio to an uneven loading of surface regions over the pressed length of the forging saddle and thus to the risk of crack formation in the surface region.

In a press with an eccentric drive, it is known (DE 10 2015 222 995 A1) to provide the eccentric shaft at one end with a flywheel which can be driven by a flywheel motor and can be releasably coupled to the eccentric shaft using a coupling. At the opposite end, the eccentric shaft is permanently connected to a torque motor which accelerates the eccentric shaft to the speed of the flywheel for the press stroke before the flywheel is coupled to the eccentric shaft for the press stroke. The interaction of the flywheel motor and the torque motor means that the installation space for the press stroke drive can be kept comparatively small. However, such an eccentric shaft drive is less suitable for the outer die part of the die parts of a forging device which can be radially displaced relative to one another and whose inner die part carrying a forging tool is drive-connected to the outer die part by a hydraulic cylinder.

### SUMMARY OF THE INVENTION

It is desirable to provide a method for the hot forming of a cast forging ingot by forge pressing in such a way that, despite an advantageous influence on the microstructure in the core region of the forging ingot, crack formation in the surface region can be largely excluded.

In the system described herein, the forging ingot is formed under a heat, first with the aid of the forging dies driven by the eccentric drive, in near-surface forge processing with a degree of deformation which is above the critical degree of deformation and which excludes the formation of cracks, and then, with the outer die parts stopped, with the aid of the inner die parts driven by the hydraulic cylinders, in forge pressing with a bite ratio >0.5.

By forge processing the forging ingot according to the system described herein in one or more passes prior to forge pressing, depending on an initial cross-section of a cast structure, the cast structure is to be refined in a region close to the surface by recrystallization in such a way that during subsequent forge pressing the locally varying loads on the forging ingot over the pressed length of the forging saddle can no longer give rise to crack formation. For this purpose, it is useful to ensure as uniform a forming as possible over the pressed saddle length in order to avoid dead material in this area, i.e. material with only a low degree of forming. This is achieved by radial forging with a degree of deformation low enough to avoid cracking but of sufficient size for recrystallization, i.e., above the critical degree of deformation which indicates the minimum deformation required to provide sufficient recrystallization nuclei for recrystallization. For this purpose, the forging dies are driven by the eccentric drives, with the aid of which, at a comparatively high stroke frequency, a small pressed saddle length is achieved compared with the effective engagement length of the forging tools, so that the flow sheath and thus the dead material in the region of the flow sheath is outside the length of the crack-prone surface pressed by the forging tool.

In the subsequent processing of the forging ingot with the same forging tools, but now hydraulically operated in the sense of forge pressing with a large bite ratio >0.5, a microstructure improvement effective down to the core of the forging ingot can be achieved, but only if the forge pressing is carried out at the same heat in order to avoid grain growth due to reheating and thus an increase in the risk of cracking.

To improve the surface quality, the forging ingot can be subjected to radial forging again with the same forging tools after forge pressing by actuating the forging dies again by the eccentric drives.

To carry out the forging method according to the system described herein, known forging devices with radially guided forging dies can be used, each of which has two die parts which can be radially displaced relative to one another, of which the inner die part carrying a forging tool is drive-connected to the other outer die part by a hydraulic cylinder, while the outer die part can be driven by an eccentric drive. In order to create simple design conditions, torque motors designed as internal rotors can be provided for driving the eccentric shaft of the eccentric drives, the rotor of which torque motors is rotatably mounted on the eccentric shaft or an eccentric shaft extension in connection with a driver flange of the eccentric shaft, where for coupling between the motor and the eccentric shaft there is preferably provided a driver which is parallel to the eccentric shaft and is mounted in the rotor so as to be axially loadable and which driver in the coupling position engages positively in a driver receptacle in the driver flange. In the coupling position, the eccentric shaft is thus driven directly by the associated torque motor. Since in this case the hydraulic cylinder between the inner and outer die parts is locked, the forging dies are driven only in the sense of radial forging by the associated eccentric drives with a comparatively small stroke and high stroke frequency. By contrast, with decoupled eccentric drives, the inner die parts can be acted upon by the hydraulic cylinders between the inner and outer die parts in the sense of forge pressing with a comparatively large stroke and low stroke frequency. The forging forces are transmitted via the outer die parts to the eccentric shaft and via this to the frame holding the forging dies. To avoid the resulting torques on the eccentric shaft, the latter is advantageously held in the outer dead center position in the uncoupled position. The hydraulic cylinders for driving the inner die parts are pressurized using pumps driven by the torque motors.

### BRIEF DESCRIPTION OF DRAWINGS

The system described herein is explained in more detail on the basis of the drawings, wherein:

FIG. 1 shows a schematic representation of the engagement of the forging tools driven by an eccentric drive for near-surface forge processing,

FIG. 2 shows a representation corresponding to FIG. 1 of the engagement of the forging tools during press forging with the aid of the hydraulically actuated forging dies, and

FIG. 3 shows a forging device according to the system described herein for carrying out the forging method in the region of a forging die in a schematic section along the eccentric shaft of the eccentric drive.

### DETAILED DESCRIPTION OF VARIOUS EMBODIMENTS

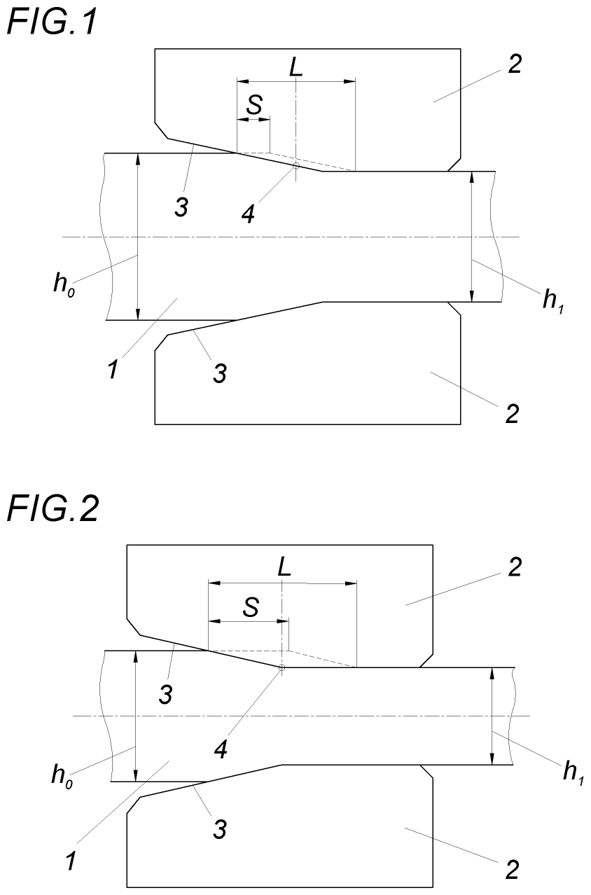

In order to permit forging of a cast forging ingot 1 in the sense of the most uniform possible recrystallization of the cast structure in an area close to the surface, the pressed saddle length S, i.e. the length of the surface region pressed by the forging dies 2 per forging stroke, which is susceptible to cracking due to the lack of forming, is kept small in comparison with the effective engagement length L of the forging dies 2 lying opposite each other in relation to the forging ingot 1. To avoid large differences between local degrees of deformation, the forging dies 2 can advantageously be provided with an entry slope 3 of between 6 and 15°. Since the dead material subject to only slight deformation per forging stroke is located in the region of the flow sheath 4, which for simplicity is indicated in the schematic representation according to FIGS. 1 and 2 in the center of the effective engagement length L of the forging dies 2, the region of slight deformation is located in the case of the forging ratios depicted in FIG. 1 outside the pressed saddle length S, so that a largely uniform forming of the forging ingot 1 in a region close to the surface can be ensured if, in order to maintain the forging ratios, the forging tools 2 are driven with a comparatively high stroke frequency. However, the forming operation must not give rise to cracking in the surface region. For this reason, the degree of deformation must be limited. For steel materials, an accumulated degree of deformation of 0.2 to 1, preferably 0.2 to 0.6, depending on the initial cross-section of the forging ingot and the number of passes dependent thereon, has proved advantageous at a deformation rate of between 0.15 and 2 per second. The accumulated degree of deformation φ=[⅔((φₕ²+φₗ²+φ_{b}²)]^{1/2} is obtained from the logarithmic degrees of deformation given by the logarithmic ratios of the dimensions after and before deformation in height h, the length l and the width b of the forging ingot 1 [φₕ=ln(h₁/h₀), φₗ=ln(l₁/l₀), φ_{b}=ln(b₁/b₀)].

After preforming in the surface region, the forging ingot 1 can be subjected under the same heat to the actual forming for compaction and microstructure improvement down to the core area by a forging press, using the same forging tools 2, but under conditions of a forging press with a bite ratio B=S/h₀>0.5, as illustrated in FIG. 2. Due to the large bite ratio, the deformations act right into the core of the forging ingot 1 when the cross-section is reduced accordingly, wherein it must be accepted that the flow sheath 4 will come to lie within the pressed saddle length S. However, the resulting non-uniform forming in the surface region does not play any role with regard to crack formation because recrystallization has already taken place in the regions close to the surface, which prevents cracking occurring with larger grain structures. The forging tools 2 are hydraulically driven for forging according to FIG. 2 at a forming speed <0.6 s⁻¹, where the cross-section reduction per pass is to be greater than 15%.

Following forge pressing, the forging ingot 1 can be subjected to near-surface forge processing similar to FIG. 1 to improve dimensional accuracy and surface finish.

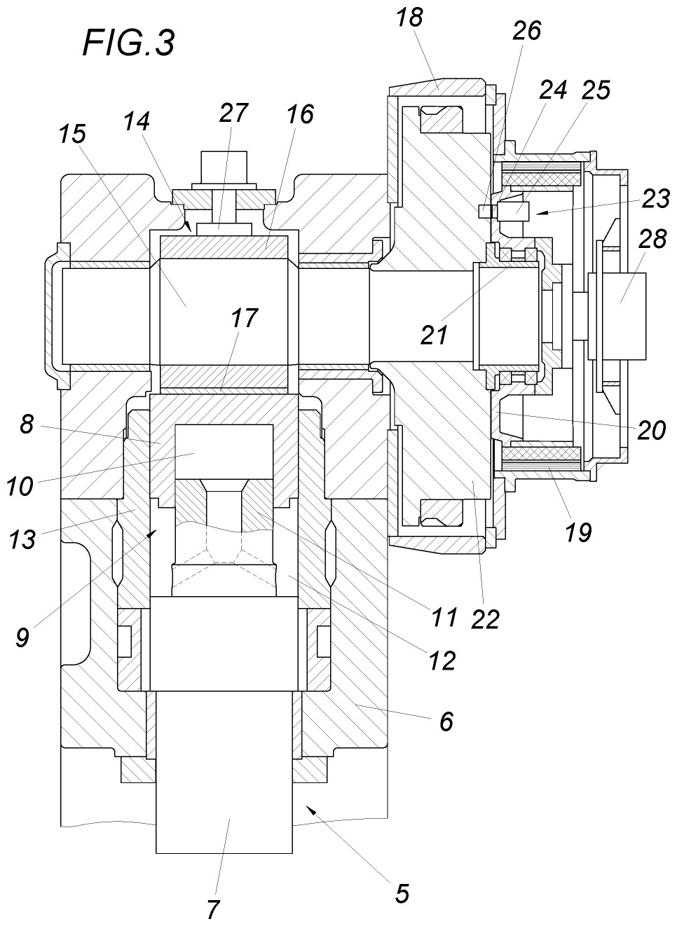

A forging device advantageous for carrying out the forging method according to FIGS. 1 and 2 is shown in FIG. 3, namely in the region of one of the forging dies 5 opposite each other in pairs with respect to a forging axis, each of which accommodates a forging tool. The forging die 5, which is guided for displacement radially to the forging axis in a frame 6, consists of two die parts, namely an inner die part 7 receiving the forging tool and an outer die part 8, between which and the inner die part 7 a hydraulic cylinder 9 is effective. The arrangement is such that the outer die part 8 forms a cylinder recess 10 in which the inner die part 7 engages with a piston section 11. The space 12 between the piston section 11 and the die guide 13 is also used as a cylinder space for acting on the inner die part 7.

The outer die part 8 is driven by an eccentric drive 14, which includes an eccentric shaft 15 mounted in the frame 6 and a sliding block 16 mounted on the eccentric shaft 15, which sliding block is supported with a sliding surface 17 of the sliding block 16 on the end face of the outer die part 8. The contact of the outer die part 8 with the sliding surface 17 of the slide block 16 is advantageously ensured by a resilient loading of the outer and inner die parts 7, 8, respectively, preferably with the aid of hydraulic springs, which, however, is not shown in more detail for reasons of clarity.

The eccentric drive 14 is driven by a torque motor 19 in the form of an internal rotor flanged to a housing 18 connected to the frame 6 coaxially with the eccentric shaft 15, the rotor 20 of which is rotatably mounted on an eccentric shaft extension 21. The eccentric shaft extension 21 is arranged on a driver flange 22 forming a flywheel, between which driver flange 22 and the rotor 20 a coupling 23 is provided. A driver 24 serves as the coupling 23, which can be displaced with the aid of an actuating cylinder 25 and, in the coupling position, engages in a driver receptacle 26 in the driver flange 22.

In the coupled engagement position, the driver flange 22 and the eccentric shaft 15 are thus driven by the torque motor 19, so that the forging die 5 is driven with a comparatively high frequency, because the two die parts 7, 8 are rigidly drive-connected to each other by the locked hydraulic cylinder 9. If, on the other hand, the coupling 23 is released and the eccentric drive 14 is held in the outer dead center position shown, the sliding block 16 forms a fixed abutment for the outer die part 8 with the result that the inner die part 7 can be subjected to press strokes as shown in FIG. 2 by the hydraulic cylinder 9 between the two die parts 7, 8 independently of the eccentric drive 14. In order to be able to better transmit the forging forces occurring to the frame 6, an additional abutment 27 for the slide block 16 can be provided in the outer dead center position of the eccentric drive 14.

As shown in FIG. 3, the torque motor 19 can advantageously drive a hydraulic pump 28 so that hydraulic fluid is available to act on the hydraulic cylinder 9 when the coupling 23 is disengaged and the torque motor 19 is running.

Since a forging device according to FIG. 3 can be switched over in a simple manner from a drive of the forging dies 5 by eccentric drives 14 for a usual radial forging to a hydraulic drive designed for a forging press using hydraulic cylinders 9, the forging device can be used in an advantageous manner for successive processing of a cast forging ingot 1 on the one hand by radial forging and on the other hand by forging under one heat, in order to avoid crack formation in the surface region during subsequent forge pressing with the preceding near-surface radial forging of the forging ingot 1.

1. A method for hot forming of a cast forging ingot using a forging device having radially guided forging dies, each having two die parts which can be radially moved relative to one another and of which an inner die part of the two die parts bearing a forging tool is drive-connected by a hydraulic cylinder to an other outer die part of the two die parts which can be driven by an eccentric drive, the method comprising:
initially forming the forging ingot under a heat with the aid of the forging dies driven by the eccentric drive, in near-surface forge processing with a degree of deformation which is above a critical degree of deformation and which excludes the formation of cracks;
following initially forming the forging ingot, stopping the outer die parts; and
using the inner die parts driven by the hydraulic cylinders to forge press the ingot with a bite ratio >0.5 while the outer die parts are stopped.

2. The method according to claim 1, further comprising:
subjecting the forging ingot to a finishing operation after forge pressing using the forging dies driven by the eccentric drive.

3. A forging device for hot forming of a cast forging ingot, comprising:
radially guided forging dies, each having two die parts which can be radially displaced relative to one another, an inner die part of the two die parts carrying a forging tool and being drive-connected to an other outer die part of the two die parts by a hydraulic cylinder;
an eccentric drive which can drive the outer die part;
an eccentric shaft coupled to the eccentric drive via a coupling to an electric motor; and
a pump driven by the electric motor, for acting on the hydraulic cylinder between the inner and outer die parts wherein the electric motor is a torque motor which is coaxial with the eccentric shaft a rotor of the torque motor being rotatably mounted on the eccentric shaft or an eccentric shaft extension in connection with a driver flange of the eccentric shaft, and wherein the coupling is arranged between the rotor and the driver flange.

4. The forging device according to claim 3, the coupling has a driver which is parallel to the eccentric shaft, is mounted in the rotor such that the coupling can be acted upon axially and, in a coupling position, engages positively in a driver receptacle in the driver flange.
